(19) United States
(12) Patent Application Publication
(10) Pub. No.: US 2026/0236633 A1
(43) Pub. Date: Aug. 13, 2026

(54) METHODS, DEVICES, AND SYSTEM FOR IMPROVING VIRTUAL POWER PLANTS (VPPS)

(71) Applicant: IoTecha Corp., Cranbury, NJ (US)

(72) Inventor: Oleg Logvinov, Weston, CT (US)

(21) Appl. No.: 19/639,444

(22) Filed: Apr. 6, 2026

Related U.S. Application Data
(63) Continuation of application No. PCT/US24/50000, filed on Oct. 4, 2024.
(60) Provisional application No. 63/588,453, filed on Oct. 6, 2023.

(51) Int. Cl. G06F 30/18; G06Q 50/06

(52) U.S. Cl. CPC G06F 30/18; G06Q 50/06

(57) ABSTRACT

Disclosed herein are methods, devices, and systems for improving performance of virtual power plants (VPPs). According to one embodiment, a programmatic method of managing a VPP includes receiving residential infrastructure data associated with the VPP. The residential infrastructure data includes a plurality of vehicle-to-grid charging capabilities associated with a plurality of electric vehicle (EV) chargers. The programmatic method further includes receiving residential behavioral data associated with the VPP. The residential behavioral data includes driving patterns of a plurality of EVs associated with the plurality of EV chargers. The programmatic method further includes determining predicted power availability information associated with the VPP based on the residential infrastructure data and the residential behavioral data using a machine learning model. The predicted power availability information is valid for a time period greater than one hour. The programmatic method further includes providing the predicted power availability information to a server associated with a wholesale energy market.

### PRIORITY CLAIM

This application is a continuation of PCT Patent Application No. PCT/US 24/50000 (Attorney Docket No. 1281/37 PCT), titled “METHODS, DEVICES, AND SYSTEMS FOR IMPROVING VIRTUAL POWER PLANTS (VPPS),” filed Oct. 4, 2024, which claims the benefit of U.S. Provisional Patent Application Ser. No. 63/588,453 (Attorney Docket No. 1281/37 PROV), titled “METHODS, DEVICES, AND SYSTEMS FOR IMPROVING VIRTUAL POWER PLANTS (VPPS),” filed Oct. 6, 2023, the entire contents of all of which are hereby incorporated by reference.

### TECHNICAL FIELD

The present invention relates generally to the field of electrical grid management. More particularly, methods, devices, and systems are disclosed for improving performance and reliability of virtual power plants (VPPs).

### BACKGROUND

The United States (US) Department of Energy defines a virtual power plant (VPP) as “a connected aggregation of distributed energy resource (DER) technologies.” As one example, the batteries of electric vehicles (EVs) connected to home chargers within a residential neighborhood may form a VPP and supply power back to the electrical grid during peak load times or power outages.

Accordingly, there remains a need for methods, devices, and systems for improving performance and reliability of VPPs.

### SUMMARY

Disclosed herein are methods, devices, and systems for improving performance of virtual power plants (VPPs). In one embodiment a programmatic method is disclosed for managing a VPP. The programmatic method includes (1) receiving residential infrastructure data associated with the VPP, (2) receiving residential behavioral data associated with the VPP, (3) determining predicted power availability information associated with the VPP based on the residential infrastructure data and the residential behavioral data, and (4) storing the predicted power availability information in memory.

In some embodiments, the programmatic method may further include transmitting the predicted power availability information over a network to a remote server. In further embodiments, the remote server may be associated with a wholesale energy market. In other embodiments, the remote server may be associated with an electric utility. In further embodiments, the electric utility may provide distribution of energy for sale within a regulated market.

In some embodiments, determining the predicted power availability information may be further based on a machine learning model. In further embodiments, the machine learning model may be a deep learning model. In further embodiments, the programmatic method may further include training the machine learning model using a first portion of the residential behavioral data and determining the predicted power availability information may be further based on a second portion of the residential behavioral data. In still further embodiments, the programmatic method may further include further training the machine learning model using additional data associated with another VPP.

In some embodiments, the residential infrastructure data may include EV charger data. In further embodiments, the EV charger data may include grid location data associated with a plurality of EV chargers. In still further embodiments, the EV charger data may further include a plurality of vehicle-to-grid (V2G) charging capabilities associated with the plurality of EV chargers. In still further embodiments, the EV charger data may further include EV power availability information associated with a portion of the plurality of EV chargers.

In some embodiments, the residential behavioral data may be received from a plurality of mobile devices associated with the plurality of EV chargers. In further embodiments, a portion of the residential behavioral data may include EV usage statistics associated with a plurality of EVs associated with the plurality of EV chargers. In still further embodiments, the EV usage statistics may include driving patterns associated with the plurality of EVs. In still further embodiments, the EV usage statistics may include energy stored and available for vehicle-to-grid energy transfers associated with the plurality of EVs associated with the plurality of EV chargers over one or more time periods.

In some embodiments, the programmatic method may further include receiving EV users preference data and determining the predicted power availability information may be further based on the EV users preference data. In further embodiments, the EV users preference data may include a plurality of preferred times for availability of vehicle-to-grid energy transfers for each EV of a plurality of EVs associated with the VPP. In still further embodiments, the EV users preference data may include a plurality of minimum monetary values per unit energy for each EV of a plurality of EVs associated with the VPP for vehicle-to-grid energy transfers. In still further embodiments, the EV users preference data may include a plurality of preferred times for availability of vehicle-to-grid energy transfers for each EV charger of a plurality of EV chargers associated with the VPP. In still further embodiments, the EV users preference data may include a plurality of minimum monetary values per unit energy for each EV charger of a plurality of EV chargers associated with the VPP for vehicle-to-grid energy transfers. In still further embodiments, the EV users preference data may include a plurality of preferred times for availability of grid-to-vehicle energy transfers for each EV of a plurality of EVs associated with the VPP. In still further embodiments, the EV users preference data may include a plurality of maximum monetary values per unit energy for each EV of a plurality of EVs associated with the VPP for grid-to-vehicle energy transfers. In still further embodiments, the EV users preference data may include a plurality of preferred times for availability of grid-to-vehicle energy transfers for each EV charger of a plurality of EV chargers associated with the VPP. In still further embodiments, the EV users preference data may include a plurality of maximum monetary values per unit energy for each EV charger of a plurality of EV chargers associated with the VPP for grid-to-vehicle energy transfers.

In some embodiments, the predicted power availability information may be valid for a period of approximately one hour or greater. In further embodiments, the predicted power availability information may be valid for a period of approximately twelve hours or greater. In still further embodiments, the predicted power availability information may be valid for a period of approximately twenty-four hours or greater. In still further embodiments, the predicted power availability information may be valid for a period of approximately one week or greater. In still further embodiments, the predicted power availability information may be valid for a period of approximately one month or greater. In still further embodiments, the predicted power availability information may be valid for a period of approximately one year or greater.

In some embodiments, the VPP may be associated with a neighborhood. In further embodiments, the VPP may be associated with a home owners association. In other embodiments, the VPP may be associated with a township. In further embodiments, the VPP may be associated with a county. In other embodiments, the VPP may be associated with a hotel or a motel. In still other embodiments, the VPP may be associated with a plurality of condominiums, a plurality of townhomes, an apartment complex, and/or the like. In still other embodiments, the VPP may be associated with a trailer park, an RV park, a campground, and or the like.

In some embodiments, the VPP may be associated with a plurality of EV users associated with an organization. In further embodiments the organization may be a business, a club, a religious group, and/or the like.

In some embodiments, the VPP may be associated with a plurality of EV users associated with a group within a social network. For example, the social network is Instagram® Facebook®, Twitter®, TikTok®, a Pinterest®, Snapchat®, or the like.

In some embodiments, the VPP may be associated with a plurality of EV users associated with a group within a professional network. For example, the professional network may be LinkedIn® or the like.

In some embodiments, at least a portion of the programmatic method may be implemented on a first server. For example, the first server may be a portion of a networked computing environment. In further embodiments, the first server may be associated with a wholesale energy market. In other embodiments, the programmatic method may further include transmitting the predicted power availability information over a network to a second server associated with a wholesale energy market and the first server may be distinct from the wholesale energy market.

In another embodiment, a computing device for managing a VPP is disclosed. The computing device includes a memory and at least one processor. The computing device is configured for (1) receiving residential infrastructure data associated with the VPP, (2) receiving residential behavioral data associated with the VPP, (3) determining predicted power availability information associated with the VPP based on the residential infrastructure data and the residential behavioral data, and (4) storing the predicted power availability information in memory.

In another embodiment, a non-transitory computer-readable storage medium is disclosed. The non-transitory computer-readable storage medium stores instructions to be implemented on at least one computing device including at least one processor. The instructions when executed by the at least one processor cause the at least one computing device to perform a method for managing a VPP. The method includes (1) receiving residential infrastructure data associated with the VPP, (2) receiving residential behavioral data associated with the VPP, (3) determining predicted power availability information associated with the VPP based on the residential infrastructure data and the residential behavioral data, and (4) storing the predicted power availability information in memory.

In another embodiment, a method implemented on a mobile device for supporting management of a VPP is disclosed. The method includes (1) receiving location tracking data associated with movement of the mobile device, (2) receiving EV user preference data associated with providing vehicle-to-grid energy transfers from an EV, and (3) transmitting the location tracking data and the EV user preference data to a remote server configured for determining predicted power availability information for the VPP.

In some embodiments, the mobile device may be smart phone, a smart tablet, a smart watch, or the like. In other embodiments, the mobile device may be embedded within an EV.

In some embodiments, the location tracking data may be determined at least in part by GNSS radios within the mobile device.

In some embodiments, the EV user preference data may include preferred times for availability of vehicle-to-grid energy transfers for an EV associated with the VPP.

In some embodiments, the EV user preference data may include a minimum monetary value per unit energy for vehicle-to-grid energy transfers for an EV associated with the VPP.

In some embodiments, the EV user preference data may include preferred times for availability of vehicle-to-grid energy transfers for an EV charger associated with the VPP.

In some embodiments, the EV user preference data may include a minimum monetary value per unit energy for vehicle-to-grid energy transfers for an EV charger associated with the VPP.

In some embodiments, the EV user preference data may include preferred times for availability of grid-to-vehicle energy transfers for an EV associated with the VPP.

In some embodiments, the EV user preference data may include a maximum monetary value per unit energy for grid-to-vehicle energy transfers for an EV associated with the VPP.

In some embodiments, the EV user preference data may include preferred times for availability of grid-to-vehicle energy transfers for an EV charger associated with the VPP.

In some embodiments, the EV user preference data may include a maximum monetary value per unit energy for grid-to-vehicle energy transfers for an EV charger associated with the VPP.

In some embodiments, the EV user preference data may be received from a GUI associated with the mobile device. In certain embodiments, the GUI may be provided by an application specific program. In further embodiments, the application specific program may be an iOS® app, an Android® OS app, or the like. In other embodiments, the GUI may be provided by a web browser. In certain embodiments, the web browser may be a Microsoft Internet Explorer® browser, a Microsoft Edge® browser, an Apple Safari® browser, a Google Chrome® browser, a Mozilla Firefox® browser, an Opera® browser, or the like.

In another embodiment, a mobile device configured for supporting management of a VPP is disclosed. The mobile device includes a memory and at least one processor. The mobile device is configured for (1) receiving location tracking data associated with movement of the mobile device, (2) receiving EV user preference data associated with providing vehicle-to-grid energy transfers from an EV, and (3) transmitting the location tracking data and the EV user preference data to a remote server configured for determining predicted power availability information for the VPP.

In some embodiments, the mobile device may be smart phone, a smart tablet, a smart watch, or the like. In other embodiments, the mobile device may be embedded within an EV.

In another embodiment, a non-transitory computer-readable storage medium is disclosed. The non-transitory computer-readable storage medium stores instructions to be implemented on a mobile device. The instructions when executed by the mobile device perform a method for supporting management of a VPP. The method includes (1) receiving location tracking data associated with movement of the mobile device, (2) receiving EV user preference data associated with providing vehicle-to-grid energy transfers from an EV, and (3) transmitting the location tracking data and the EV user preference data to a remote server configured for determining predicted power availability information for the VPP.

In some embodiments, the mobile device may be smart phone, a smart tablet, a smart watch, or the like. In other embodiments, the mobile device may be embedded within an EV.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings'exemplary embodiments; however, the presently disclosed invention is not limited to the specific methods and instrumentalities disclosed. In the drawings:

FIG. 1 depicts a flow chart illustrating a method of managing a VPP using a machine learning model in accordance with embodiments of the present disclosure.

FIG. 2 depicts a flow chart illustrating a method implemented on a mobile device for supporting management of a VPP in accordance with embodiments of the present disclosure.

FIG. 3 depicts a block diagram illustrating a system that includes a VPP managing server, a plurality of mobile devices, a plurality of EV chargers, and a plurality of EVs in accordance with embodiments of the present disclosure.

FIG. 4 depicts a block diagram further illustrating one embodiment of a mobile device of FIG. 3 in accordance with embodiments of the present disclosure.

FIG. 5 depicts a block diagram 500 further illustrating one embodiment of an EV charger of FIG. 3 in accordance with embodiments of the present disclosure.

FIG. 6 depicts one embodiment for the VPP managing server of the system of FIG. 3 in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

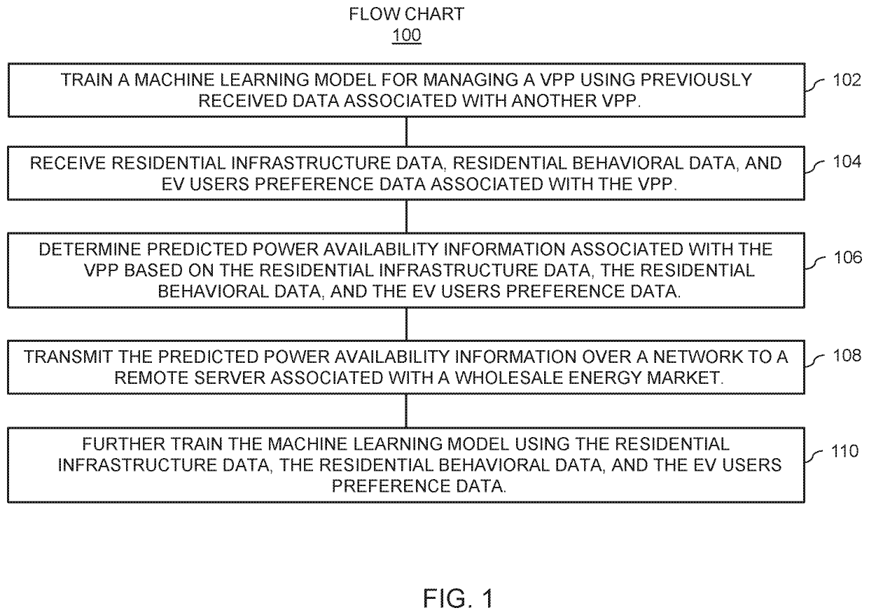

Disclosed herein are methods, systems, and devices for improving performance and reliability of virtual power plants (VPPs). FIG. 1 depicts a flow chart 100 illustrating a method of managing a VPP using a machine learning model in accordance with embodiments of the present disclosure. The machine learning model may include a supervised learning model, an unsupervised learning model, a reinforcement learning model, and/or an ensemble learning model. The supervised learning model may include classification functions and/or regression functions. The unsupervised learning model may include clustering functions, dimensionality reduction functions, and/or association functions. The reinforcement learning model may include model-free methods, model-based methods, and/or value-based methods. The ensemble learning model may include bagging functions, boosting functions, and/or stacking functions. The machine learning model may also include a deep learning model.

The VPP may be associated with a neighborhood, a home owners association, a township, a county, or a zip code. The VPP may also be associated with a hotel, a motel, a plurality of condominiums, a plurality of townhomes, or an apartment complex. Additionally, the VPP may be associated with a trailer park, a recreational vehicle (RV) park, or a campground. An organization may be associated with the VPP. For example, employees of a business may decide to use their EVs as a VPP when either parked at home or at work. Likewise, participants in a club, religious group, or even a group within a social or professional network may decide to do the same. A group within Instagram® Facebook®, Twitter®, TikTok®, a Pinterest®, or Snapchat®, and/or LinkedIn® may provide their EVs as a VPP.

In step 102, the method includes training the machine learning model using previously received data associated with another VPP. The previously received data may include residential infrastructure data, residential behavioral data, and electric vehicle (EV) users preference associated with the other VPP.

In step 104, the method further includes receiving residential infrastructure data, residential behavioral data, and EV users preference data associated with the VPP. The residential infrastructure data may include EV charger data. The EV charger data may include grid location data associated with a plurality of EV chargers, a plurality of vehicle-to-grid (V2G) charging capabilities associated with the plurality of EV chargers, and/or EV power availability information associated with a portion of the plurality of EV chargers.

The residential behavioral data may be received from a plurality of mobile devices associated with the plurality of EV chargers. A portion of the residential behavioral data may include EV usage statistics associated with a plurality of EVs associated with the plurality of EV chargers. The EV usage statistics may include driving patterns associated with the plurality of EVs. The EV usage statistics may also include energy stored and available for vehicle-to-grid energy transfers associated with the plurality of EVs associated with the plurality of EV chargers over one or more time periods.

The EV users preference data may also be received from the plurality of mobile devices associated with the plurality of EV chargers. The EV users preference data may include a plurality of preferred times for availability of vehicle-to-grid energy transfers for each EV of a plurality of EVs associated with the VPP, a plurality of minimum monetary values per unit energy for each EV of for vehicle-to-grid energy transfers, a plurality of preferred times for availability of vehicle-to-grid energy transfers for each EV charger, a plurality of minimum monetary values per unit energy for each EV charger for vehicle-to-grid energy transfers, a plurality of preferred times for availability of grid-to-vehicle energy transfers for each EV, a plurality of maximum monetary values per unit energy for each EV for grid-to-vehicle energy transfers, a plurality of preferred times for availability of grid-to-vehicle energy transfers for each EV charger, and/or a plurality of maximum monetary values per unit energy for each EV charger for grid-to-vehicle energy transfers.

In step 106, the method further includes determining predicted power availability information associated with the VPP based on the residential infrastructure data, the residential behavioral data, and the EV users preference data using the machine learning model. The predicted power availability information may be valid from a few minutes, a few days, a few weeks, or even a few months depending on the complexity of the machine learning model.

In step 108, the method further includes transmitting the predicted power availability information over a network to a remote server associated with a wholesale energy market. Alternately or in addition, the method may further include transmitting the predicted power availability information over the network to an electric utility that provides distribution of energy for sale within a regulated market.

In step 110, the method further includes further training the machine learning model using the residential infrastructure data, the residential behavioral data, and the EV users preference data

The method (not shown in FIG. 1) may also include transmitting a request to one or more of the plurality of mobile devices for the EV user to connect their EV to the given EV charger for providing vehicle-to-grid and grid-to-vehicle energy transfers.

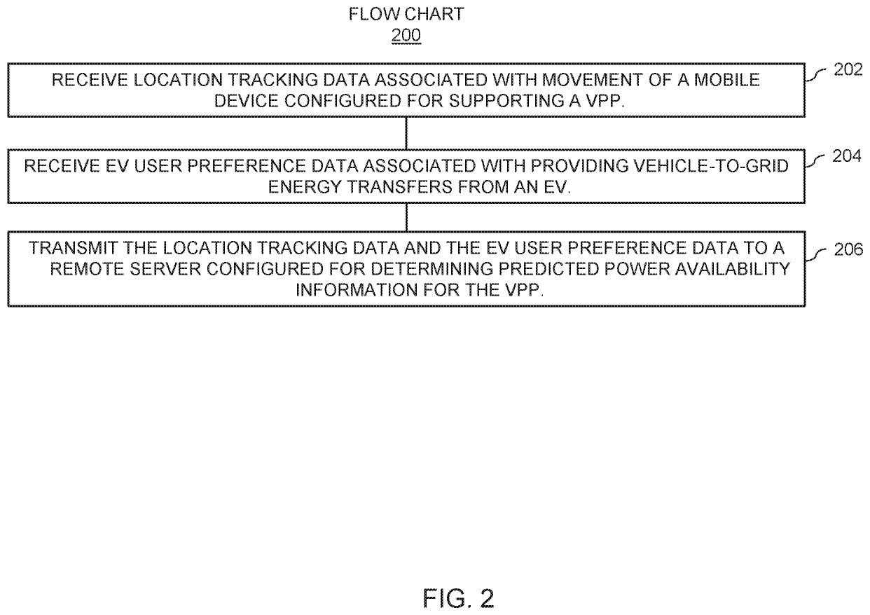

FIG. 2 depicts a flow chart 200 illustrating a method implemented on a mobile device for supporting management of a VPP in accordance with embodiments of the present disclosure. The mobile device may be a smart phone, a smart tablet, a smart watch, or the like. Alternately, the mobile device may be embedded within an EV.

In step 202, the method includes receiving location tracking data associated with movement of the mobile device. The location tracking data may be determined at least in part by global navigation satellite system (GNSS) radios within the mobile device.

In step 204, the method further includes receiving EV user preference data associated with providing vehicle-to-grid and grid-to-vehicle energy transfers from an EV. The EV user preference data may be received from a graphical user interface (GUI) associated with the mobile device. The GUI may be provided by an application specific program (e.g., an iOS® app, an Android® OS app, or the like. Alternately, the GUI may be provided by a web browser (e.g., a Microsoft Internet Explorer® browser, a Microsoft Edge® browser, an Apple Safari® browser, a Google Chrome® browser, a Mozilla Firefox® browser, an Opera® browser, or the like).

The EV user preference data may include preferred times for availability of vehicle-to-grid energy transfers from the EV, a minimum monetary value per unit energy for vehicle-to-grid energy transfers for the EV, preferred times for availability of vehicle-to-grid energy transfers for an EV charger associated with the EV, a minimum monetary value per unit energy for vehicle-to-grid energy transfers for the EV charger, a minimum monetary value per unit energy for vehicle-to-grid energy transfers for the EV charger, preferred times for availability of grid-to-vehicle energy transfers for the EV, a maximum monetary value per unit energy for grid-to-vehicle energy transfers for the EV, preferred times for availability of grid-to-vehicle energy transfers for the EV charger, and/or a maximum monetary value per unit energy for grid-to-vehicle energy transfers for the EV charger.

In step 206, the method further includes transmitting the location tracking data and the EV user preference data to a remote server configured for determining predicted power availability information for the VPP.

The method (not shown in FIG. 2) may also include receiving a request from the remote server to connect the EV to the EV charger for providing vehicle-to-grid and grid-to-vehicle energy transfers.

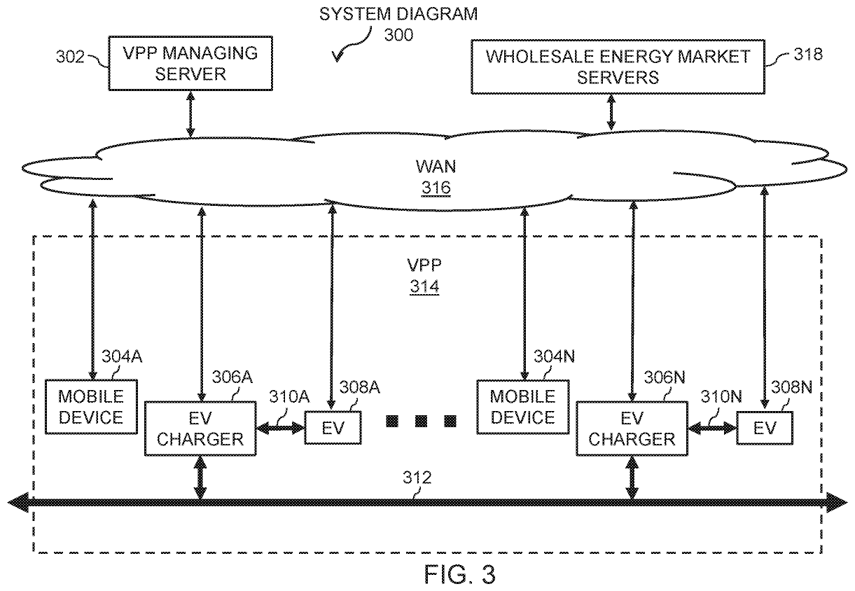

FIG. 3 depicts a block diagram illustrating a system 300 that includes a VPP managing server 302, a plurality of mobile devices 304A-304N, a plurality of EV chargers 306A-306N, and a plurality of EVs 308A-308N in accordance with embodiments of the present disclosure. The plurality of EV chargers 306A-306N are electrical coupled to an alternating current (AC) electrical grid 312. The plurality of EVs 308A-308N may be intermittently coupled via a plurality of direct current (DC) connections 310A-310N to the EV chargers 308. Each EV charger 306 may operate independently in one of two modes. In a first mode, the EV charger 306 provides grid-to-vehicle energy transfers from the AC electrical grid 312. (I.E. The EV charger 306 chargers the batteries of the EV 308 via the AC electrical grid 212. In a second mode, the EV charger 306 provides vehicle-to-grid energy transfers from the batteries of the EV 308 to the AC electrical grid 312. (I.E. The batteries of the EV 308 supply DC power to the EV charger 306 and an inverter in the EV charger 306 supplies AC power back to the AC electrical grid 312. The plurality of EV chargers 306A-306N and the plurality of EVs 308A-308N form an on-demand VPP.

The VPP managing server 302 receives data from the plurality of mobile devices 304A-304N, the plurality of EV chargers 306A-306N, and the plurality of EVs 308A-308N over the wide area network (WAN) 316 to update a machine learning model. The WAN 316 may include the Internet and any combination of 2G, 3G, 4G, and 5G networks. The WAN 316 may also include Data Over Cable Service Interface Specification (DOCSIS) networks and/or fiber networks such as passive optical networks (PONs).

The machine learning model then determines predicted power availability information for the VPP 312. The predicted power availability information is then transmitted to one or more wholesale energy market servers 318. The VPP managing server 302 may be configured to implement the method(s) described in FIG. 1 and the plurality of mobile devices 304A-304N may be configured to implement the method(s) described in FIG. 2.

In some embodiments, the functions of the VPP managing server 302 may be integrated into the wholesale energy market servers 318. Additionally, one or more of the plurality of EV chargers 306A-306N may be integrated into one or more of the plurality of EVs 308A-308N. (I.E. The EV 308 that then electrically couple directly with the AC electrical grid for grid-to-vehicle or vehicle-to-grid energy transfers.)

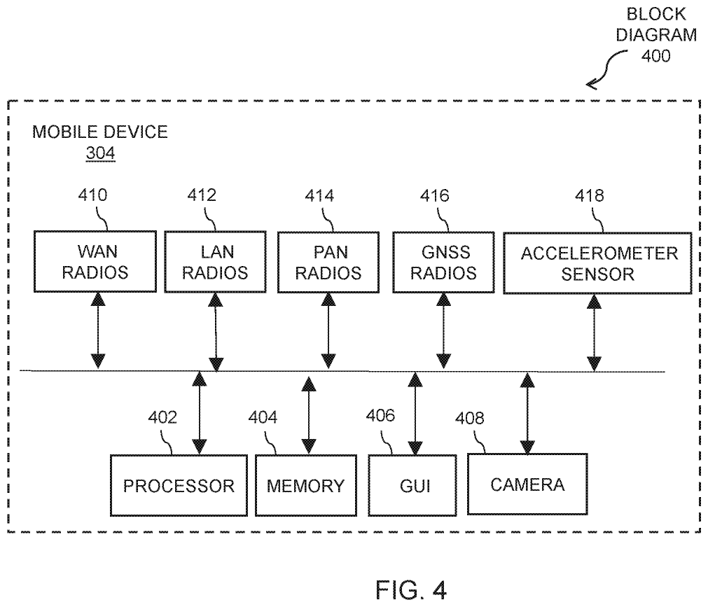

FIG. 4 depicts a block diagram 400 further illustrating one embodiment of the mobile device 304 of FIG. 3 in accordance with embodiments of the present disclosure. The mobile device 304 may be a smart phone (e.g., cell phone), a tablet, a laptop, a smart watch, or the like. The mobile device 304 includes a processor 402, a memory 404, a graphical user interface (GUI) 406, a camera 408, WAN radios 410, LAN radios 412, PAN radios 414, GNSS radios 416, and one or more accelerometer sensors 418.

In some embodiments, the mobile device 304 may be an iPhone® or an iPad®, using iOS® as an operating system. In other embodiments, the mobile device 304 may be a mobile terminal including Android® operating system, BlackBerry® OS, Windows Phone®OS, or the Like.

In some embodiments, the processor 402 may be a mobile processor such as the Qualcomm® Snapdragon™ mobile processor. The memory 404 may include a combination of volatile memory (e.g., random access memory) and non-volatile memory (e.g., flash memory). The memory 404 may be partially integrated with the processor 402. The GUI 406 may be a touchpad display. The WAN radios 410 may include 2G, 3G, 4G, and/or 5G technologies. The LAN radios 412 may include Wi-Fi technologies such as 802.11a, 802.11b/g/n, 802.11ac, 802.11.ax or the like circuitry. The PAN radios 414 may include Bluetooth® technologies.

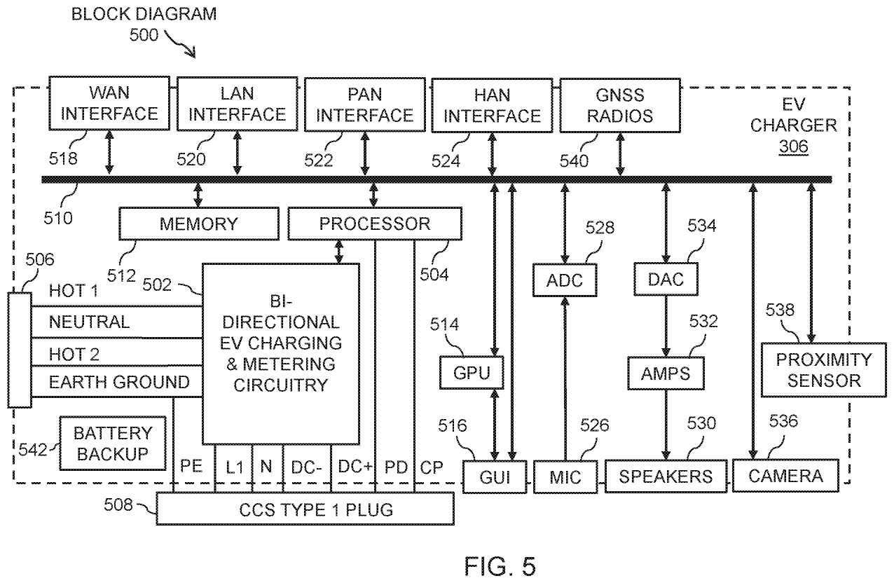

FIG. 5 depicts a block diagram 500 further illustrating one embodiment of the EV charger 306 of FIG. 3 in accordance with embodiments of the present disclosure. The EV charger 306 includes EV charging circuitry 502, a processor 504 electrically coupled with the bi-directional EV charging and metering circuitry 502, an alternating current (AC) electrical grid interface 506 electrically coupled with the bi-directional EV charging and metering circuitry 502, and a Combined Charging System (CCS) Type 1 plug 508 electrically coupled with the bi-directional EV charging and metering circuitry 502. The AC electrical grid interface 506 includes grid hot 1 phase (i.e., a first phase), grid hot 2 phase (i.e., a second phase), grid neutral, and earth ground connections (i.e., a split-phase grid connection as is commonly known in the art).

The CCS Type 1 plug 508 is configured to be coupled with the EV 304 of FIG. 3. The CCS Type 1 plug 508 is also electrically coupled with the processor 504. The processor 508 is configured to monitor a Proximity Detection (PD) contact to confirm connection to the EV 304. The processor 508 is further configured to monitor a control pilot (CP) contact to maintain a charging rate within a safe operating limit of the EV 304. The bi-directional EV charging and metering circuitry 502 is configured to provide AC power to the CCS Type 1 plug 508. The bi-directional EV charging and metering circuitry 502 includes switch circuitry for enabling and/or disabling AC power to the CCS Type 1 plug 508 via a first AC (L1) contact and a second AC (N) contact. The L1 contact and the N contact provide AC power to internal charging circuitry within the EV 304. The switch circuitry may include a relay and the relay may be a solid state relay. The bi-directional EV charging and metering circuitry 502 may also include an AC-to-DC rectifier for providing DC power to the EV charging interface via a DC+ contact and a DC− contact. The DC+ contact and the DC− contact provide charging current directly to the battery pack of the EV 304 in this scenario. A protective earth (PE) contact of the CCS Type 1 plug 508 is electrically coupled with earth ground of the AC electrical grid interface 506.

The EV charger 306 also includes a bus 510 electrically coupling the processor 504 with a memory 512, a graphical processing unit (GPU) 514, and a GUI 516. The bus 510 also electrically couples a WAN interface 518, a local area LAN interface 520, a PAN interface 522, and a home area network (HAN) 524 with the processor 204. The WAN interface 518 is configured to communicate with the VPP managing server 302 via the WAN 310. In some embodiments, the LAN interface 520 may be configured to indirectly communicate with the WAN 310. The LAN interface 520 may also be configured to communicate with the mobile device 304. The WAN interface 518 may include 2G, 3G, 4G, and/or 5G technologies. The LAN interface 520 may include Wi-Fi technologies such as 802.11a, 802.11b/g/n, and/or 802.11ac circuitry. The PAN interface 522 may include Bluetooth® technologies.

A microphone (mic) 526 is electrically coupled with the bus 510 via an analog-to-digital converter (ADC) 528. Speakers 530 are also electrically coupled with the bus 510 via amplifiers (amps) 532 and at least one digital-to-analog converter (DAC) 534. Additionally, a camera 536 is electrically coupled with the processor 504 via the bus 510. In some embodiments, the bus 510 may be replaced by multiple buses and/or point-to-point connections. A proximity sensor 538 is electrically coupled with the processor 504 via the bus 210. The EV charger 306 also includes GNSS radios 540 electrically coupled with the bus 510. The GNSS radios 540 facilitate the processor 504 in determining a present location of the EV charger 306.

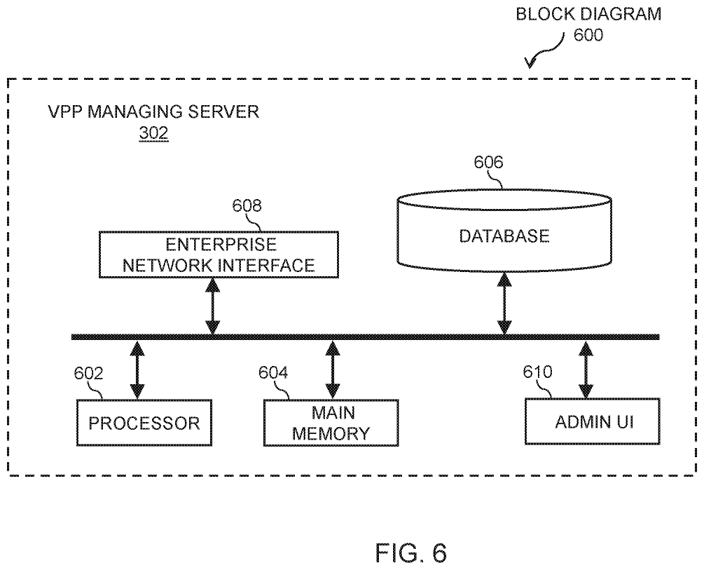

FIG. 6 depicts one embodiment for the VPP managing server 302 of the system 300 of FIG. 3 in accordance with embodiments of the present disclosure. The VPP managing server 302 is a hardware server and may include a processor 602, a main memory 604, a database 606, an enterprise network interface 608, and an administration user interface (UI) 610. The VPP managing server 302 may be configured to host a virtual server. For example, the virtual server may be an Ubuntu® server or the like. The VPP managing server 302 may also be configured to host a virtual container. For example, the virtual container may be the Docker® virtual container or the like. In some embodiments, the virtual server and or virtual container may be distributed over a plurality of hardware servers using hypervisor technology. The VPP managing server 302 may be implemented in the Microsoft Azure®, the Amazon Web Services® (AWS), or the like cloud computing data center environments. In other embodiments, the VPP managing server 302 may be hosted within a business or residential environment.

The processor 602 may be a multi-core server class processor suitable for hardware virtualization. The processor 602 may support at least a 64-bit architecture and a single instruction multiple data (SIMD) instruction set. The main memory 604 may include a combination of volatile memory (e.g., random access memory) and non-volatile memory (e.g., flash memory). The database 606 may include one or more hard drives. In some embodiments, the database 606 may be an open source database such as the MongoDB® database, the PostgreSQL® database, or the like. The database 606 may be configured to store residential infrastructure data, residential behavioral data, and EV users preference data, predicted power availability information, and actual historical power availability information associated with one of more VPPs.

The enterprise network interface 608 may provide one or more high-speed communication ports to the data center switches, routers, and/or network storage appliances. The enterprise network interface 608 may include high-speed optical Ethernet, InfiniBand (IB), Internet Small Computer System Interface iSCSI, and/or Fibre Channel interfaces. The administration UI 610 may support local and/or remote configuration of the VPP managing server 302 by a data center administrator or the like. The enterprise network interface 608 allows the VPP managing server 302 to communicate over the network 310.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. For example, programming languages may include, but are not limited to: Ruby, JavaScript, Java, Python, Ruby, PHP, C, C++, C #, Objective-C, Go, Scala, Swift, Kotlin, OCaml, or the like.

Machine learning is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A programmatic method of managing a virtual power plant (VPP), the programmatic method comprising:
receiving residential infrastructure data associated with the VPP;
receiving residential behavioral data associated with the VPP;
determining predicted power availability information associated with the VPP based on the residential infrastructure data and the residential behavioral data; and
storing the predicted power availability information in memory.

2. The programmatic method of claim 1 further comprising transmitting the predicted power availability information over a network to a remote server.

3. The programmatic method of claim 2, wherein the remote server is associated with a wholesale energy market.

4. The programmatic method of claim 2, wherein the remote server is associated with an electric utility.

5. The programmatic method of claim 1, wherein determining the predicted power availability information is further based on a machine learning model.

6. The programmatic method of claim 1, wherein the residential infrastructure data comprises electric vehicle (EV) charger data.

7. The programmatic method of claim 6, wherein the EV charger data further includes EV power availability information associated with a portion of a plurality of EV chargers.

8. The programmatic method of claim 1 further comprising receiving EV users preference data and determining the predicted power availability information is further based on the EV users preference data.

9. The programmatic method of claim 8, wherein the EV users preference data includes a plurality of preferred times for availability of vehicle-to-grid energy transfers for each EV of a plurality of EVs associated with the VPP.

10. The programmatic method of claim 1, wherein the predicted power availability information is valid for a period of approximately twenty-four hours or greater.

11. The programmatic method of claim 1, wherein the VPP is associated with a neighborhood or a home owners association.

12. The programmatic method of claim 1, wherein the VPP is associated with a hotel or a motel.

13. The programmatic method of claim 1, wherein the VPP is associated with a plurality of condominiums, a plurality of townhomes, or an apartment complex.

14. The programmatic method of claim 1, wherein the VPP is associated with a plurality of EV users associated with an organization.

15. The programmatic method of claim 14, wherein the organization is a business, a club, a religious group, or a social network.

16. The programmatic method of claim 1, wherein the VPP is associated with a plurality of EV users associated with a group within a professional network.

17. The programmatic method of claim 1, wherein:
the programmatic method is implemented on a first server;
the programmatic method further comprises transmitting the predicted power availability information over a network to a second server associated with a wholesale energy market; and
the first server is distinct from the wholesale energy market.

18. A method implemented on a mobile device for supporting management of a virtual power plant (VPP), the method comprising:
receiving location tracking data associated with movement of the mobile device;
receiving electric vehicle (EV) user preference data associated with providing vehicle-to-grid energy transfers from an EV; and
transmitting the location tracking data and the EV user preference data to a remote server configured for determining predicted power availability information for the VPP.

19. The method of claim 18, wherein the EV user preference data is received from a graphical user interface (GUI) associated with the mobile device.

20. A non-transitory computer-readable storage medium, the non-transitory computer-readable storage medium storing instructions to be implemented on a mobile device configured for supporting management of a virtual power plant (VPP), the instructions when executed by at least one processor of the mobile device perform a method comprising:
receiving location tracking data associated with movement of the mobile device;
receiving electric vehicle (EV) user preference data associated with providing vehicle-to-grid energy transfers from an EV; and
transmitting the location tracking data and the EV user preference data to a remote server configured for determining predicted power availability information for the VPP for the VPP.
